(19) United States
(12) Patent Application Publication
(10) Pub. No.: US 2011/0199969 A1
(43) Pub. Date: Aug. 18, 2011

(54) GTPv2 NODE

(75) Inventor: Yong YANG, Molndal (SE)

(73) Assignee: TELEFONAKTIEBOLAGET L M ERICSSON (publ), Stockholm (SE)

(21) Appl. No.: 12/979,633

(22) Filed: Dec. 28, 2010

Related U.S. Application Data
(63) Continuation of application No. PCT/EP2010/070755, filed on Dec. 27, 2010.
(60) Provisional application No. 61/305,703, filed on Feb. 18, 2010.

(51) Int. Cl. H04W 4/00

(52) U.S. Cl. 370/328

(57) ABSTRACT

A GTPv2 node for an E-UTRAN or a GERAN/UTRAN access system, arranged to comprise in a session related signaling message to a peer GTPv2 node information in an information element which indicates that the GTPv2 node supports a certain feature which is identified in the information element. The information element also indicates to the peer GTPv2 node that the peer GTPv2 node should indicate information about its own support or non-support for the feature in the information element in a session related signaling message which is sent as a result of the session related signaling message from the GTPv2 node, as well as including information about the GTPv2 node's support for the feature.

### BACKGROUND

When an Evolved Packet Core network is utilized in an access system such as an E-UTRAN or a GERAN/UTRAN access system, in order to use such Packet Data services as, for example, Voice over IP, VoIP, or Streaming Services, a User Equipment, here abbreviated as UE, needs to set up a Packet Data Network connection which involves either the logical entity known as MME, Mobility Management Entity, or an SGSN (GERAN/UTRAN) alternatively an S4-SGSN (E-UTRAN), as well as a Serving Gateway, SGW, and a Packet Data Gateway, PGW. In addition, a number of other system entities are also involved in serving a UE during a session with an Evolved Packet Core network.

The protocol known as the GPRS Tunneling Protocol, abbreviated as GTP, in particular the version known as v2, i.e. GTP v2, is used for many of the interfaces between the entities involved in serving a UE during a session with an Evolved Packet Core network. By means of the GTPv2 protocol, the various nodes in the system exchange information in so called information elements, IEs.

The GTPv2 exists in a number of releases, the most recent one at present being release 10. Naturally, there will always be many nodes in a network or in a system which utilize older releases of GTPv2 than the most recent release, regardless of whether or not the most recent release is release 10 or a later one, and later releases of GTPv2 may add IEs which don't exist in previous releases of GTPv2. A problem in this respect is that a GTPv2 node which receives an unknown IE will simply discard the unknown IE. Since the unknown IE probably originates from a GTPv2 node which utilizes a more recent release of GTPv2 than the receiving node, this is a “legacy” problem with the GTPv2 releases.

### SUMMARY

It is an object of some of the example embodiments to solve some of the disadvantages caused by the GTPv2 “legacy” problem explained above. This object may be achieved by some of the example embodiments in that it discloses a GTPv2 node for an E-UTRAN or a GERAN/UTRAN access system which may be arranged to comprise in a session related signaling message to a peer GTPv2 node information in an information element which indicates that the GTPv2 node supports a certain feature which is identified in the information element.

In adding, the information element may also indicate to the peer GTPv2 node that the peer GTPv2 node should indicate information about the GTPv2 peer node's own support or non-support for the feature in the information element in a session related signaling message which it may send as a result of the session related signaling message from the GTPv2 node, as well as including information about the GTPv2 node's support for the feature.

Thus, in this manner, a GTPv2 node of a certain release will be able to inform a peer GTPv2 node that the GTPv2 node supports a certain feature, and the peer GTPv2 node will react by indicating its own support of the same feature either to the GTPv2 node or to a remote peer GTPv2 node. The information element will not be discarded, and a proper answer may be returned to the GTPv2 node.

Accordingly, in some embodiments, the GTPv2 may be arranged to receive a response message from the peer GTPv2 node in response to the session related signaling message. The response message may comprise information in the same information element regarding the peer node's support or non-support for said feature.

In some embodiments, the GTPv2 node may be arranged to receive a response message from the peer GTPv2 node in response to the session related signaling message. The response message may comprise information in said information element regarding a remote peer node's support or non-support for said feature.

Some example embodiments may also disclose a GTPv2 node for an E-UTRAN or a GERAN/UTRAN access system which may be arranged to receive in a session related signaling message from a first peer GTPv2 node information in an information element which may indicate that the first peer GTPv2 node supports a certain feature which is identified in the information element. The information element may also indicate to the GTPv2 node that the GTPv2 node should indicate information about its own support or non-support for the feature in the information element in a session related signaling response message which is sent as a result of the session related signaling message from the first peer GTPv2 node, as well as information about the first peer GTPv2 node's support for the feature.

In this way, a GTPv2 node is disclosed which can receive information about a peer GTPv2 node's support for feature, and which can then indicate its own support or non-support in another message to the original GTPv2 node or to a GTPv2 node which is a remote GTPv2 node relative to the peer GTPv2 node.

Thus, in some example embodiments, the GTPv2 node may be arranged to send the session related signaling response message to the first peer node.

In some example embodiments, the GTPv2 node may be arranged to send the session related signaling response message to a GTPv2 node in the system which may be a remote peer GTPv2 node relative to the peer GTPv2 node and to receive in response in a session related signaling message an information element which may indicate the remote peer GTPv2 node's support or non-support for said feature, and may comprise information about the remote peer GTPv2 node's support or non-support for said feature in a session related signaling response message to the GTPv2 node.

In some example embodiments, the GTPv2 node mentioned above may be an E-UTRAN Mobility Management Entity or a GERAN/UTRAN S4-SGSN, or a Serving Gateway for an E-UTRAN or a GERAN/UTRAN access system.

In some example embodiments of the GTPv2 node mentioned above, the session related signaling message may be, as an example, one of the following messages: Create Session Request, Create Session Response, Modify Bearer Request or Modify Bearer Response.

In some example embodiments, the GTPv2 node mentioned above may be a Serving Gateway or a Packet Data Gateway for an E-UTRAN or a GERAN/UTRAN access system.

Some example embodiments may comprise a General packet radio service Tunneling Protocol version 2 (GTPv2) node. The node may comprise a communications port that may be configured to receive an information element in a session related signaling message, and an indication unit that may be configured to indicate in the information element a support or nonsupport of a General packet radio service Tunneling Protocol version 2 (GTPv2) node with respect to a specified feature.

Some example embodiments may comprise a method for communication. The method may comprise receiving an information element in a session related signaling message, and indicating in the information element a support or nonsupport of a General packet radio service Tunneling Protocol version 2 (GTPv2) node with respect to a specified feature.

### BRIEF DESCRIPTION OF THE DRAWINGS

The example embodiments will be described in more detail in the following, with reference to the appended drawings, in which

FIGS. 1 and 2 show the architecture of systems in which some of the example embodiments can be applied, and

FIG. 3 shows an example of an Information Element used in some of the example embodiments, and

FIGS. 4 and 5 show examples of signaling diagrams which may be used in some of the example embodiments, and

FIG. 6 shows an example of a node which may use some of the example embodiments.

### DETAILED DESCRIPTION

The example embodiments will be described more fully hereinafter with reference to the accompanying drawings, in which the example embodiments are shown. The example embodiments may, however, be embodied in many different forms and should not be construed as being limited to the embodiments set forth herein. Like numbers in the drawings refer to like elements throughout.

The terminology used herein is for the purpose of describing particular embodiments only, and is not intended to limit the example embodiments.

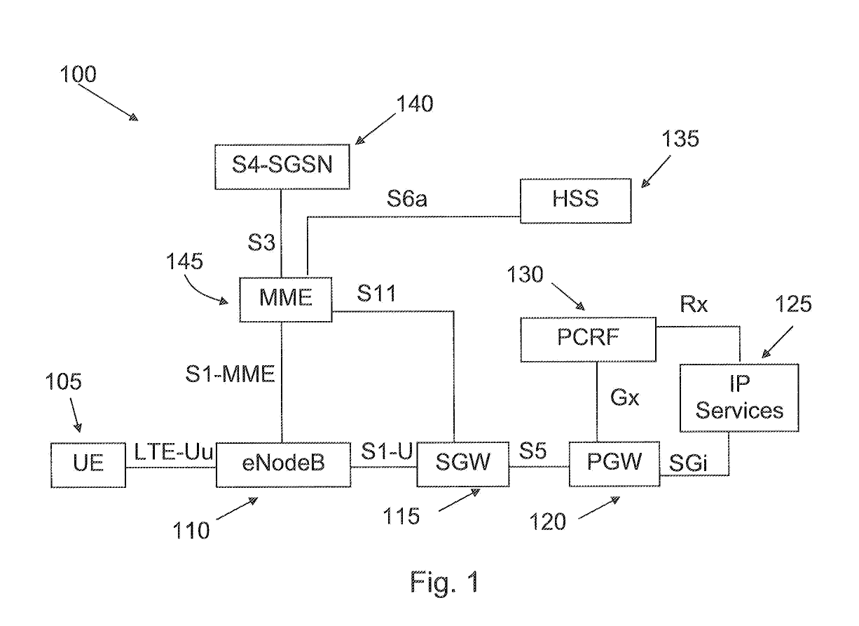

FIG. 1 shows an example of a system 100 in which some of the example embodiments can be applied. The system 100 is an E-UTRAN system. Components of the system 100 will now be identified, as well as the interface used between the various components in the system 100 of FIG. 1.

As indicated in FIG. 1, a User Equipment, a UE 105, connects to the system via an E-UTRAN base station, a so called eNodeB 110. The eNodeB 110 interfaces to a Serving Gateway, SGW 115, and to a Mobility Management Entity, MME 145. The SGW 115 also interfaces to the MME 145. In addition, the MME 145 interfaces to an S4 Serving GPRS Support Node, S4-SGSN 140, and to a Home Subscriber Server, HSS 135.

Furthermore, the SGW 115 also interfaces to a Packet Data Gateway, PGW 120. As shown, the PGW 120 interfaces to a Policy and Charging Rules Function, PCRF 130, and to an operator's IP services 125. In addition, there is an interface between the PCRF 130 and the IP services 125.

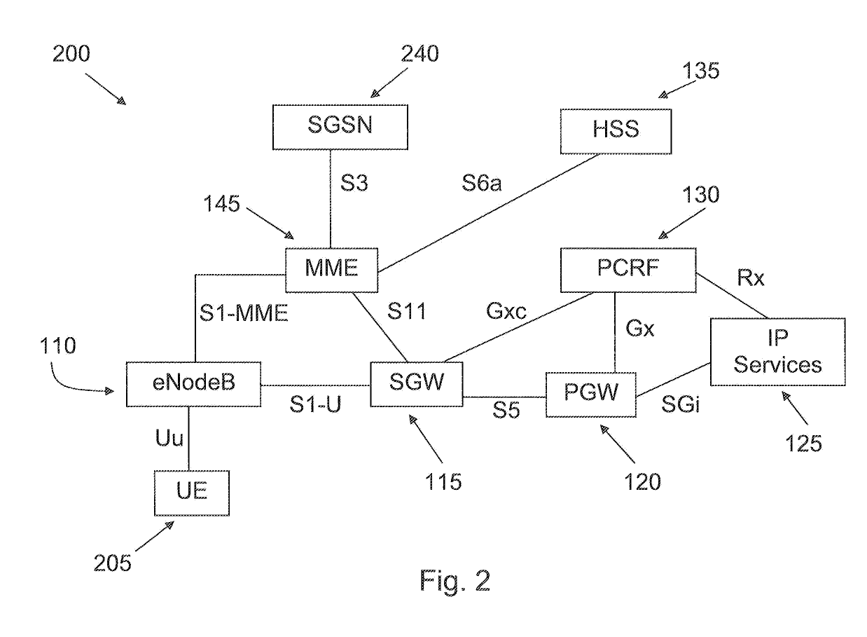

A second example of a system 200 in which some of the example embodiments can be used is shown in FIG. 2, where components from FIG. 1 have retained their reference numbers. The system 200 is a GERAN/UTRAN system. A main difference between the system 200 and the system 100 of FIG. 1 is that the S4-SGSN 140 of FIG. 1 is here replaced by a “legacy” SGSN 240, and that the PCRF 130 interfaces to the SGW 115 as well as to the PGW 120 and to the operator's IP services 125.

The GPRS Tunneling protocol version 2, GTPv2, is used in a plurality of the interfaces shown in FIGS. 1 and 2.

The interfaces in the systems 100 and 200 and the nodes between which they are used can be summed up as follows:

| Interface | Used between nodes |
|---|---|
| UU/LTE Uu | UE - eNodeB (E-UTRAN) |
| S1-U | E - UTRAN-SGW |
| S5 | SGW - PGW |
| SGi | PGW - IP Services |
| Rx | PCRF - IP Services |
| Gx | PCRF - PGW |
| S11 | MME - SGW |
| S1-MME | MME - eNodeB (E - UTRAN) |
| S3 | MME - SGSN/S4-SGSN |
| S6a | MME - HSS |

The example embodiments presented herein allow a GTPv2 node to use session related signaling messages to inform a peer GTPv2 node in the system that the GTPv2 node supports a certain feature. Example embodiments of a GTPv2 node will now be described, using an embodiment of the MME 145 in FIGS. 1 and 2 as an example of such a node, and by means of the signalling involved in the Initial Attach procedure. However, it should be pointed out that the example embodiments can also be applied in other nodes in the systems 100 and 200, as can other session related signaling messages besides those used in the example below. For example, as will be realized from the following description, the SGW 115 and the PGW 120 of FIGS. 1 and 2 are also GTPv2 nodes which are encompassed by the example embodiments.

During the Initial Attach Procedure, according to this embodiment, the MME 145 may establish a PDN Connection by sending the message Create Session Request to the SGW 115. According to some of the example embodiments, this session related signaling message may comprise a new information Element, an IE, to allow the MME 145 to inform the SGW 115 that the MME 145 supports one or more new features. The new IE may also inform the SGW 115 that the SGW 115 should use the same IE in the Create Session Request message to the PGW 120 to inform the PGW 120 that the feature or features is/are supported by the MME 145 as well as by the SGW 115 itself, and that the PGW 120 should comprise information in the same IE in its response to the Create Session Request message to the SGW 115 to indicate if the PGW 120 supports the feature or features in question.

When the PGW 120 receives the Create Session message from the SGW 115, it may reply with a Create Session Response message to the SGW 115 in which the PGW 120 has comprised the IE in question and has comprised information in the IE to indicate if the PGW 120 supports the feature or features in question or not. When the SGW 115 receives the message Create Session Response from the PGW 115, it may forward the message to the MME 120, and the IE may now hold information for the MME 120 regarding support or non-support in the SGW 115 and the PGW 120 for the features in question. Once the MME 120 has this information, it knows whether or not it can safely send new GTPv2 messages which use the feature or features in question.

The GTPv2 node which is the closest to the MME, i.e. the SGW, is also sometimes referred to as a GTPv2 “peer node”, and a GTPv2 node which is one or more GTPv2 nodes removed from the MME is sometimes referred to as a GTPv2 “remote peer node”. The same principle of naming adjacent or non-adjacent GTPv2 nodes is adhered to for other nodes as well, such as for example, for the PGW and the SGW, so that, for example, the MME is a remote peer node for the PGW, and the MME and the PGW are peer nodes for the SGW.

In order to cover the “inter-MME, intra-SGW” case, the new IE may also be comprised in the session related signaling message Modify Bearer Request Response. The “inter-MME, intra-SGW” case is the case in which a UE changes MME but not SGW during a session, In these cases, there may be no signaling between the PGW and the SGW, but the two nodes (MME and SGW) will still have exchanged their capabilities, regarding the feature or features in the new Information Element, where the PGW capabilities regarding the feature or features will be also comprised. In other words, the MME and SGW will be able to exchange their capability regarding the feature or features in the new information Element, and the PGW capabilities regarding the feature or features will be also comprised by the SGW and received by the MME

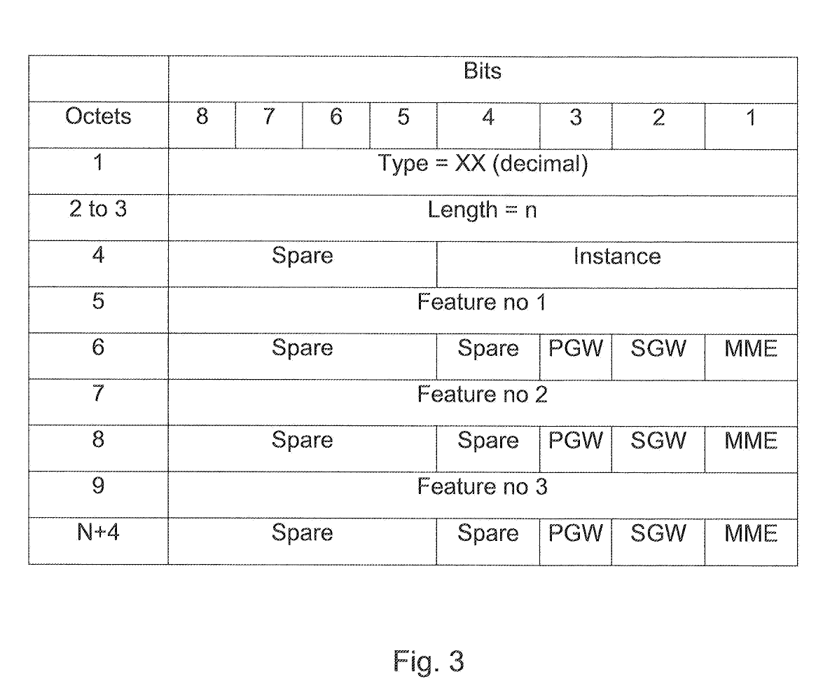

FIG. 3 shows an example of an IE used in some of the example embodiments. The IE is extendable, i.e. it can be made to hold information about the support of a node for N new features, where N is an integer equal to or larger than 1. The IE holds, in this example, 3 initial octets for showing the type and length of the IE. For each feature, the IE holds 2 octets, where one of the octets signifies the name of the feature and the other octet is used by the GTPv2 nodes to indicate their capability regarding the particular feature named in the first octet. For example, looking at the IE of FIG. 3, for the feature “Feature 1”, the name of the feature is specified in octet 5 and the capabilities of the PGW, SGW and MME are specified in bits 3, 2 and 1, respectively, of octet 6, and bits 5-8 of octet 6 are spare bits.

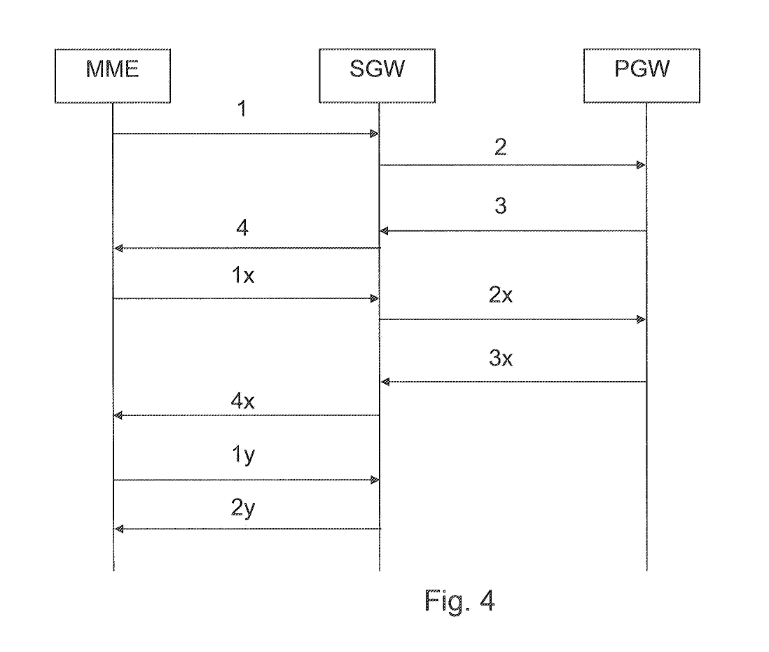

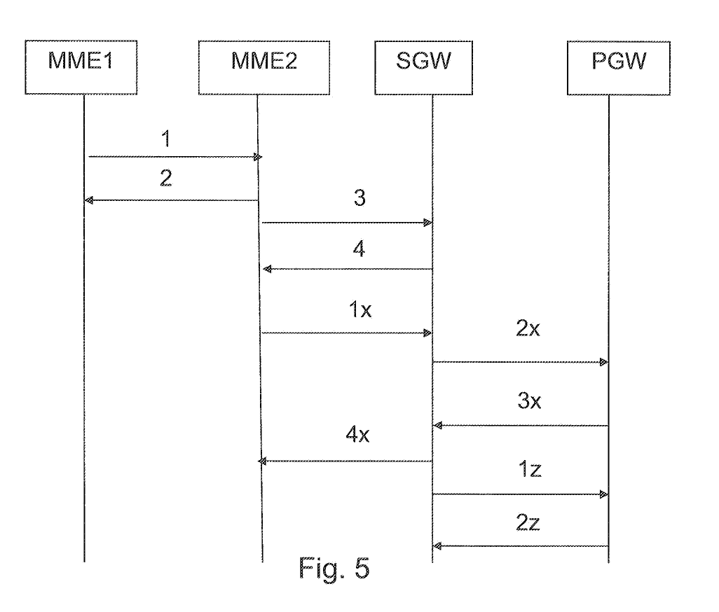

Some examples of signaling between embodiments of GTPv2 nodes of some of the example embodiments will now be given with reference to FIGS. 4 and 5.

FIG. 4 shows the signaling involved in the attach procedure. The numbering of steps 1-4 below is with reference to the arrows in FIG. 4. The GTPv2 nodes which are involved here are the MME 145, the SGW 115 and the PGW 120 of FIGS. 1 and 2.
1) During the E-UTRAN initial attach procedure, the MME may send the session related signaling message “Create Session Request” to the PGW, comprising the new IE, here also named the “Capability Flag IE”, which indicates that the MME supports feature X and feature Y. If the new IE is not comprised in the message, this means that the MME doesn't support any new features or any corresponding new GTP messages.
2) The SGW may forward the Create Session Request message from the MME to the PGW, comprising the IE “Capability flag”, and set its own capability accordingly if it supports feature X or feature Y. If the SGW is a legacy SGW, i.e. one which doesn't support new features, the legacy SGW will merely “drop” the new IE, meaning that the MME won't get the new IE in return and will thus realize that the SGW doesn't support any new features. In this example, SGW supports feature X and Y. i.e. it sets bit 2 to be equal to “1” in the octets which bear the names “Feature X” and “Feature Y” using the example of an IE from FIG. 3. Here, we assume that “1” indicates “support”, and “0” indicates “non-support”.
3) The PGW may send the Create Session Response message back to the SGW, comprising the Capability flag IE, and sets its capability accordingly if it supports this new IE. If the PGW is a legacy PGW, i.e. one which doesn't support new features, the PGW will merely “drop” the new IE, meaning that the SGW won't get the new IE in return and will thus realize that the PGW doesn't support the new features X and Y. In this example, the PGW only supports feature X, and thus sets bit 3 to be equal to “1” in the octet which bears the name “Feature X” and sets bit 3 to be equal to “0” in the octet which bears the name “Feature Y”, using the example of a “Capability flag IE” from FIG. 3.
4) The SGW may forward the Create Session Response message to the MME. the message comprising the “Capability flag IE” which now comprises both the SGW's and the PGW's support/non-support for features X and Y if the SGW supports this new IE. Otherwise, the new IE will be “dropped” by the SGW, meaning that the SGW doesn't support any new features. In this example, since the SGW supports new features X and Y and the PGW supports new feature X, the MME can now safely use new GTPv2 messages which are introduced by feature X in later stages in order to communicate with the SGW and the PGW, as shown by Steps 1x to 4x in FIG. 4. In addition, the MME can now also safely use new GTPv2 message which are introduced by feature Y in communication with the SGW as shown by Steps 1y to 2y in FIG. 4.

For a feature that involves the three nodes MME, SGW and PGW, it is not certain that PGW can be always be updated about the capability of the MME since there might no S5 signaling in, for example, the “inter MME and Intra SGW mobility case”. So, in such a case, the PGW may send a new GTP message which is supported by the old MME but not new MME, and a proper error handling is thus then needed in the SGW. In one embodiment, the SGW rejects the new message from the PGW, including a sending a cause telling the PGW that the MME doesn't support a certain feature, and at the same time the SGW comprises the Capability Flag IE to the PGW in order to update its knowledge of the MME's capability for this PDN connection. In such a case, SGW may based on the difference of supporting features in the source MME and target MME send Modify Bearer request over S5/S8 to update the “target” (new) MME capability of the supported feature. In such a case, the target MME, based on the knowledge of the source MME's capability of supported feature may comprise information element such as User Location Information to trigger SGSN to send the Modify Bearer request over S5/S8 to update the target MME capability on the supported feature.

A new cause code is added for this case, named, for example, “Remote peer doesn't support the feature”

An example of a case where this happens is shown in FIG. 5, which shows signalling between the MME 145, the SGW 115 and the PGW 120 in the inter MME and/or the intra SGW mobility case.

In the example shown in FIG. 5, an UE moves from a first MME, “MME1” to a second MME, “MME2”, and sends a “TAU request”, (TAU=Tracking Area Update), but the SGW is not relocated, so there is no S5 signaling towards the POW since the RAT (Radio Access Type) type has not changed or the MME does not need to send UE's location and/or User CSG information to the PGW. In such a case, the POW will not be updated about the capability of the new MME, i.e. MME2.
1) In steps 1 and 2, MME2 gets all of the UE context information from MME1 through the Context Request/Response procedure.
2) MME2 sends the session related signaling message Modify Bearer Request to the SGW, including the “Capability Flag IE”, and sets it to indicate its support or non-support for features X and Y. In this example, MME2 only supports feature X, so that, using the example of a “Capability Flag” IE from FIG. 3, MME2 thus sets bit 3 to be equal to “1” in the octet which bears the names “Feature X” and sets bit 3 to be equal to “0” in the octet which bears the name “Feature Y”.
3) The SGW may reply with the session related signaling message Modify Bearer Response, the message comprising the Capability Flag IE in which it has set the support or non support of both the SGW and PGW for the new features of the new IE. The SGW gets to know PGW support or non-support for these features when the PDN connection is established: the PGW indicates its capability in the Create Session Response message, and in the case of “inter MME and inter SGW” mobility, the new SGW finds out the PGW's support or non-support in the Modify Bearer Response message over the S5/S8 interface, since, in that mobility case, the new SGW will inform the MME of its capability in the Create Session Response message by setting the corresponding bit in the new IE capability flags for features X and feature Z.
4) The “new” MME, i.e. MME2, can now safely use new GTPv2 messages which are introduced by feature X in later stages of communication with the SGW and the PGW as shown in step 1x to 4x in FIG. 5.
5) If the PGW initiates any new GTPv2 messages which are connected to feature Z, since the SGW knows that MME2 doesn't support such messages, it can simply reply with the cause code “Remote peer doesn't support the feature”, and at the same time comprise the Capability Flag IE with the proper bits set, in order to update the PGW with the new MME's (MME2) capability regarding feature Z.

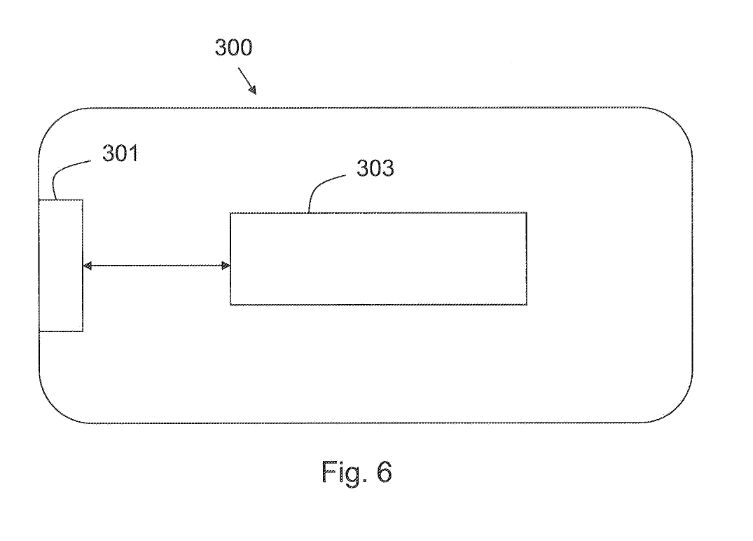

FIG. 6 is a block diagram of the GTPv2 node 300 discussed above. The GTPv2 node 300 may comprise a communications port 301 that may be configured to send and/or receive the messages featured in FIGS. 4 and 5. It should be appreciated the communications port 301 may be configured to receive and/or transmit communication data, messages or instructions known in the art. The GTPv2 node 300 may also comprise an indication unit 303 that may be configured to provide an indication of support or non support of a feature that may be specified in the information element, as described above. The indication unit 301 may be, for example, any suitable type of computation or processing unit, e.g. a microprocessor, digital signal processor (DSP), field programmable gate array (FPGA), or application specific integrated circuit (ASIC).

Some example embodiments are described with reference to the drawings, such as block diagrams and/or flowcharts. It is understood that several blocks of the block diagrams and/or flowchart illustrations, and combinations of blocks in the block diagrams and/or flowchart illustrations, can be implemented by computer program instructions. Such computer program instructions may be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

In some implementations, the functions or steps noted in the blocks may occur out of the order noted in the operational illustrations. For example, two blocks shown in succession may in fact be executed substantially concurrently or the blocks may sometimes be executed in the reverse order, depending upon the functionality/acts involved.

In the drawings and specification, there have been disclosed exemplary embodiments. However, many variations and modifications can be made to these embodiments without substantially departing from the principles of the disclosed embodiments. Accordingly, although specific terms are employed, they are used in a generic and descriptive sense only and not for purposes of limitation.

The example embodiments presented are not limited to the embodiments described above and shown in the drawings, but may be freely varied within the scope of the appended claims.

1. A method for communication comprising:
receiving an information element in a session related signaling message; and
indicating in the information element a support or nonsupport of a General packet radio service Tunneling Protocol version 2 (GTPv2) node with respect to a specified feature.

2. The method of claim 1 further comprising transmitting the information element in a response message, the transmitting being a function of the step of indicating.

3. The method of claim 1 further comprising transmitting at least one other session related signaling message to a peer GTPv2 node and/or a remote peer GTPv2 node, the at least one other session related signaling message comprising the information element.

4. The method of claim 3 further comprising indication in the information element a support or nonsupport of the peer GTPv2 node and/or the remote peer GTPv2 node with respect to the specified feature.

5. The method of claim 4 further comprising transmitting from the peer GTPv2 node and/or the remote peer GTPv2 node the information element in at least one other response message, the transmitting being a function of the step of indicating.

6. The method of claim 1 wherein the GTPv2 node is any one of an E-UTRAN Mobility Management Entity, a GERAN/UTRAN S4-SGSN, a Serving Gateway for an E-UTRAN, or a GERAN/UTRAN access system.

7. The method of claim 1, wherein the session related signaling message is any one of a Create Session Request message, Create Session Response message, Modify Bearer Request message, or a Modify Bearer Response message.

8. The method of claim 1, wherein the GTPv2 node is any one of a Serving Gateway or a Packet Data Gateway for an E-UTRAN or a GERAN/UTRAN access system.

9. A General packet radio service Tunneling Protocol version 2 (GTPv2) node, the node comprising:
a communications port configured to receive an information element in a session related signaling message; and
an indication unit configured to indicate in the information element a support or nonsupport of a General packet radio service Tunneling Protocol version 2 (GTPv2) node with respect to a specified feature.

10. The node of claim 9 wherein the communications port is further configured to transmit the information element in a response message, as a function of the information element.

11. The node of claim 9 wherein the communications port is further configured to transmit at least one other session related signaling message to a peer GTPv2 node and/or a remote peer GTPv2 node, the at least one other session related signaling message comprising the information element.

12. The node of claim 11 the communications unit is further configured to receive the information element in at least one response message from the peer GTPv2 node and/or the remote peer GTPv2 node, the response message comprising an indication of a support or nonsupport of the peer GTPv2 node and/or the remote peer GTPv2 node with respect to the specified feature.

13. The node of claim 9 wherein the GTPv2 node is any one of an E-UTRAN Mobility Management Entity, a GERAN/UTRAN S4-SGSN, a Serving Gateway for an E-UTRAN, or a GERAN/UTRAN access system.

14. The node of claim 9, wherein the session related signaling message is any one of a Create Session Request message, Create Session Response message, Modify Bearer Request message, or a Modify Bearer Response message.

15. The node of claim 9, wherein the GTPv2 node is any one of a Serving Gateway or a Packet Data Gateway for an E-UTRAN or a GERAN/UTRAN access system.
